(19) United States
(12) Patent Application Publication
(10) Pub. No.: US 2022/0060268 A1
(43) Pub. Date: Feb. 24, 2022

(54) BROADCAST RECEIVER

(71) Applicants: Chi-Yu WANG, New Taipel City (TW); ALLGO AUTOMOTIVE CO, LTD., New Taipel City (TW)

(72) Inventors: Chi-Yu WANG, New Taipel City (TW); Bing-Tsung WU, New Taipei City (TW)

(73) Assignees: ALLGO AUTOMOTIVE CO, LTD., New Taipel City (TW); Chi-Yu WANG, New Taipel City (TW)

(21) Appl. No.: 17/393,237

(22) Filed: Aug. 3, 2021

(30) Foreign Application Priority Data
Aug. 21, 2020 (TW) 109128629

(51) Int. Cl. H04H 40/18; H04H 60/70

(52) U.S. Cl. CPC H04H 40/18; H04H 60/70

(57) ABSTRACT

A broadcast receiver is capable of automatically switching to an applicable frequency of a radio station in a region, and stores plural geocodes related respectively to area blocks of the region, and plural frequencies related the radio station and each corresponding to one of the area codes. The broadcast receiver obtains a geographic coordinate set when a radio signal currently received from the radio station has poor quality. Then, the broadcast receiver converts the coordinate set to a geocode, finds an area code corresponding to the geocode, and receives the radio signal from the radio station on the frequency corresponding to the area code.

### CROSS-REFERENCE TO RELATED APPLICATION

This application claims priority of Taiwanese Patent Application No. 109128629, filed on Aug. 21, 2020.

### FIELD

The disclosure relates to a broadcast receiver, and more particularly to a broadcast receiver configured to automatically switch to an applicable frequency of a radio station.

### BACKGROUND

When driving a car, a driver of the car may turn on a radio installed on the car to listen to radio programs. However, signal strength of a radio signal received by the radio from a specific radio station may be too week when the car moves across a wide region, and thus audio output of the radio may have noise. In such case, in order to keep listening to the radio program broadcasted by the specific station, the driver has to manually operate the radio to search for and switch to another frequency so as to receive a radio signal with greater signal strength from the specific radio station, which may affect driving safety.

### SUMMARY

One object of the disclosure is to provide a broadcast receiver that can alleviate at least one of the drawbacks of the prior art.

According to one embodiment of the disclosure, the broadcast receiver is configured to automatically switch to an applicable frequency of a radio station in a region. The region has a plurality of areas each being divided into a plurality of area blocks.

The broadcast receiver includes a storage unit storing a first table and a second table, a radio-receiving unit configured to receive a radio signal, a positioning unit configured to obtain a geographic coordinate set of a location where the broadcast receiver is located, and a processing unit electrically connected to the storage unit, the radio-receiving unit and the positioning unit.

The first table includes a plurality of area codes associated respectively with the areas, and a plurality of geocodes each of which is related to all geographic coordinate sets covered by a respective one of the area blocks and each of which corresponds to one of the area codes that is associated with the area having the respective one of the area blocks. The second table includes at least one first frequency related a first radio station. Each of the at least one first frequency corresponds to one of the area codes.

The processing unit is configured to determine whether a measurement of a first radio signal currently received from the first radio station is less than a predetermined value. The measurement indicates quality of the first radio signal. Then, when it is determined that the measurement of the first radio signal is less than the predetermined value, the processing unit is configured to obtain a first current coordinate set of a first current location of said broadcast receiver via the positioning unit, convert the first current coordinate set to a first geocode, find a first area code that corresponds to the first geocode from among the area codes in the first table, determine whether the first area code corresponds to any one of the at least one first frequency in the second table, and when it is determined that the first area code corresponds to one of the at least one first frequency in the second table, control the radio-receiving unit to receive the first radio signal from the first radio station on said one of the at least one first frequency.

### BRIEF DESCRIPTION OF THE DRAWINGS

Other features and advantages of the disclosure will become apparent in the following detailed description of the embodiments with reference to the accompanying drawings, of which:

FIG. 1 is a block diagram of a broadcast receiver according to an embodiment of this disclosure;

FIG. 2 is a schematic view illustrating a vehicle moving across areas of a region;

FIG. 3 is a flow chart of a method for automatically switching to an applicable frequency of a radio station according to an embodiment of this disclosure;

FIG. 4 is a flow chart of a method for automatically switching to an applicable frequency of a radio station according to another embodiment of this disclosure;

FIG. 5 illustrates steps of a travel mode for listening to a radio program broadcasted by a local radio station according to an embodiment of this disclosure;

FIG. 6 illustrates steps of a scan mode for finding a radio station that broadcasts a radio signal with the greatest signal strength according to an embodiment of this disclosure;

FIG. 7 is a flow chart of a method for providing location-based information according to an embodiment of this disclosure;

FIG. 8 is a schematic map illustrating a vehicle moving through some administrative divisions;

FIG. 9 illustrates steps of a first quick-switching function allowing a user to quickly switch between two pre-stored frequencies according to an embodiment of this disclosure;

FIG. 10 illustrates steps of a second quick-switching function allowing the user to quickly switch among a plurality of preference frequencies according to an embodiment of this disclosure;

FIG. 11 illustrates steps of a third quick-switching function allowing the user to quickly switch among a plurality of frequencies belonging to a broadcast network according to an embodiment of this disclosure; and

FIG. 12 is a flow chart of a method for automatically playing a subscribed radio program according to an embodiment of this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. It should be further noted that reference numerals, reference symbols “A”, “B”, “C”, etc. and “a”, “b”, “c”, etc. and ordinal numbers (e.g., first, second, third, etc.) used herein are for convenience of description only, and do not indicate specific order or spatial relationship.

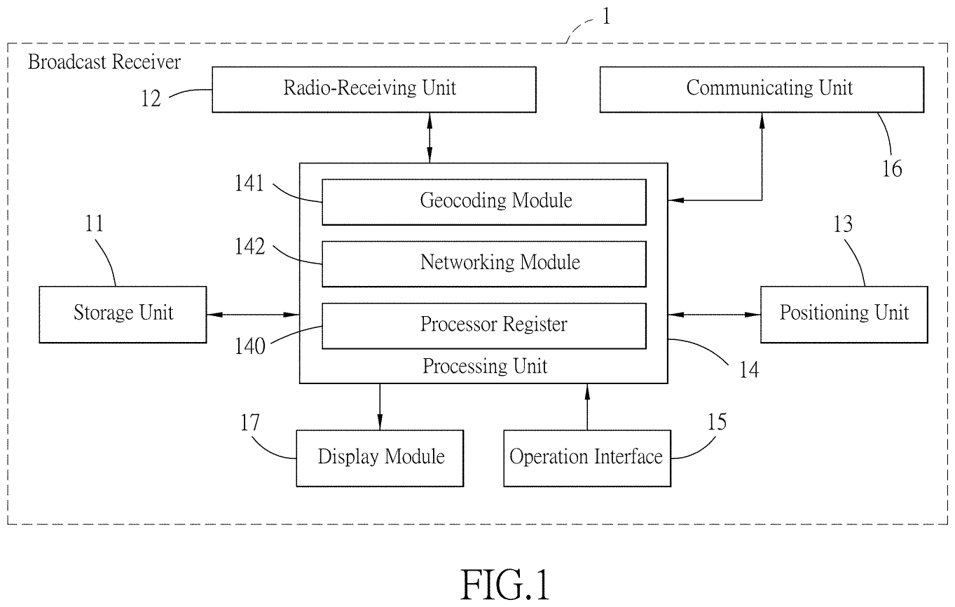

Referring to FIG. 1, a broadcast receiver 1 according to an embodiment of this disclosure is configured to automatically switch to an applicable frequency of a radio station in a region that has a plurality of areas each being divided into a plurality of area blocks. For example, the region is Taiwan, and each of the areas is a township, city or district in Taiwan. For each area, the area blocks are, for example, rectangular blocks that compose the area.

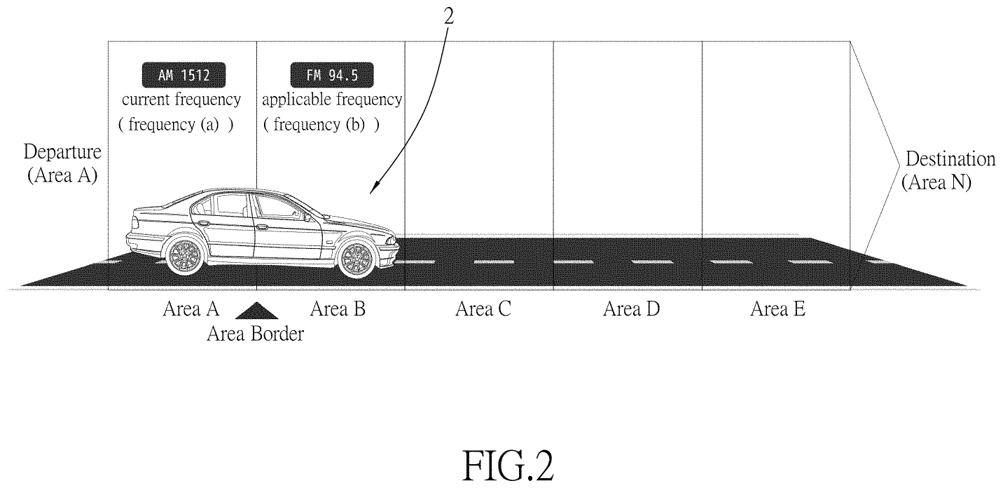

In this embodiment, the broadcast receiver 1 is adapted to be installed on a vehicle 2 (see FIG. 2) and to be used together with a speaker (not shown) of the vehicle 2. In other embodiments, the broadcast receiver 1 may be a portable radio receiver. The broadcast receiver 1 includes a storage unit 11, a radio-receiving unit 12, a positioning unit 13 (e.g., a global positioning system (GPS) receiver), and a processing unit 14 electrically connected to the storage unit 11, the radio-receiving unit 12 and the positioning unit 13. In some embodiments, the broadcast receiver 1 further includes an operation interface 15 that is electrically connected to the processing unit 14 and that is embodied using, for example, physical buttons, knobs, a touch panel or a combination thereof. In some embodiments, the broadcast receiver 1 further includes a display module 17 that is electrically connected to the processing unit 14 and that is, for example, embodied as a flat-panel display or integrated with the operation interface 15 as a touch panel.

The storage unit 11 is, for example but not limited to, an electrically-erasable programmable read-only memory (EEPROM), a hard disk, a solid-state drive (SSD), or a non-transitory storage medium (e.g., a secure digital memory, flash memory, etc.). The storage unit 11 stores a first table and a second table. The first table includes a plurality of area codes associated respectively with the areas, and a plurality of geocodes each of which is related to all geographic coordinate sets (e.g., GPS coordinate sets) covered by a respective one of the area blocks and each of which corresponds to one of the area codes that is associated with the area having the respective one of the area blocks. Specifically, the geocodes correspond respectively to the area blocks, and for each area block, all geographic coordinate sets in the area block will be converted to the same geocode. The geocodes can be obtained by converting the geographic coordinate sets using a conventional geocoding algorithm such as, but not limited to, S2 Geometry provided by Google and Geohash invented by Gustavo Niemeyer. Alternatively, the geocodes can be obtained from existing geocoding data.

The following Table 1 is an example of the first table. In Table 1, there are three area codes (i.e., 101, 102 and 103) associated respectively with Area A, Area B and Area C, and thirteen geocodes (aa11-aa14, bb11-bb14 and cc11-cc15) corresponding respectively to Area Blocks 1-13. In the case that the region is Taiwan, Area A is, for example, Daan District of Taipei City. It should be noted that, in reality, Daan District should have much more than four area blocks. For each of the areas, the area code may be a postal code of the area, or a predetermined code composed of plural digits of numbers and/or letters.

TABLE 1

| Geocode | | Area Code |
|---|---|---|
| Area Block 1 | aa11 | 101 |
| Area Block 2 | aa12 | (Area A) |
| Area Block 3 | aa13 | |
| Area Block 4 | aa14 | |
| Area Block 5 | bb11 | 102 |
| Area Block 6 | bb12 | (Area B) |
| Area Block 7 | bb13 | |
| Area Block 8 | bb14 | |
| Area Block 9 | cc11 | 103 |
| Area Block 10 | cc12 | (Area C) |
| Area Block 11 | cc13 | |
| Area Block 12 | cc14 | |
| Area Block 13 | cc15 | |

The second table includes at least one first frequency related a first radio station, and at least one second frequency related to a second radio station. Specifically, in the second table, each of the at least one first frequency corresponds to one of the area codes, and each of the at least one second frequency of the second radio station corresponds to one of the area codes. It should be noted that the correspondence of a frequency of a radio station to an area code means that a radio receiver (e.g., the broadcast receiver 1) can receive a radio signal from the radio station on this frequency in an area associated with the area code.

The following Table 2 is an example of the second table. In Table 2, the first radio station has a frequency (a) corresponding to the area code “101” and a frequency (b) corresponding to the area code “102,” and does not have a frequency corresponding to the area code “103.” That is to say, a radio receiver can receive a radio signal from the first radio station in Area A and Area B, which correspond respectively to the area codes “101” and “102,” but not in Area C which corresponds to the area code “103.” In other words, the frequencies (a) and (b) are the first frequencies for the first radio station. Similarly, the second radio station has a frequency (c) corresponding to the area code “102” and a frequency (d) corresponding to the area code “103,” and does not have a frequency corresponding to the area code “101.” In other words, the frequencies (c) and (d) are the second frequencies for the second radio station. It should be noted that, in other embodiments, the second table may include other frequencies or relate to more than two radio stations.

TABLE 2

| Radio Station | Area Code | Frequency |
|---|---|---|
| First Radio | 101 | frequency (a) |
| Station | 102 | frequency (b) |
| | 103 | N/A |
| Second Radio | 101 | N/A |
| Station | 102 | frequency (c) |
| | 103 | frequency (d) |

The radio-receiving unit 12 includes, for example, a conventional radio receiver circuit configured to receive amplitude-modulated (AM) radio waves and frequency-modulated (FM) radio waves, and/or a conventional digital radio circuit configured to receive digital signals. The radio-receiving unit 12 is configured to be controlled by the processing unit 14 to receive a radio signal on a frequency. Specifically, the processing unit 14 may transmit to the radio-receiving unit 12 a tuning signal indicating a specific frequency, and then, in response to receipt of the tuning signal, the radio-receiving unit 12 adjusts a passband thereof to the specific frequency indicated by the tuning signal.

The positioning unit 13 is controlled by the processing unit 14 to obtain a geographic coordinate set (e.g., a GPS coordinate set) of a location where the broadcast receiver 1 is currently located, and to transmit the geographic coordinate set to the processing unit 14.

The processing unit 14 is a microcontroller or a controller such as, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. In this embodiment, the processing unit 14 includes a geocoding module 141 configured to implement the above-mentioned conventional geocoding algorithm. The geocoding module 141 may be embodied in: executable software as a set of logic instructions stored in a machine-or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

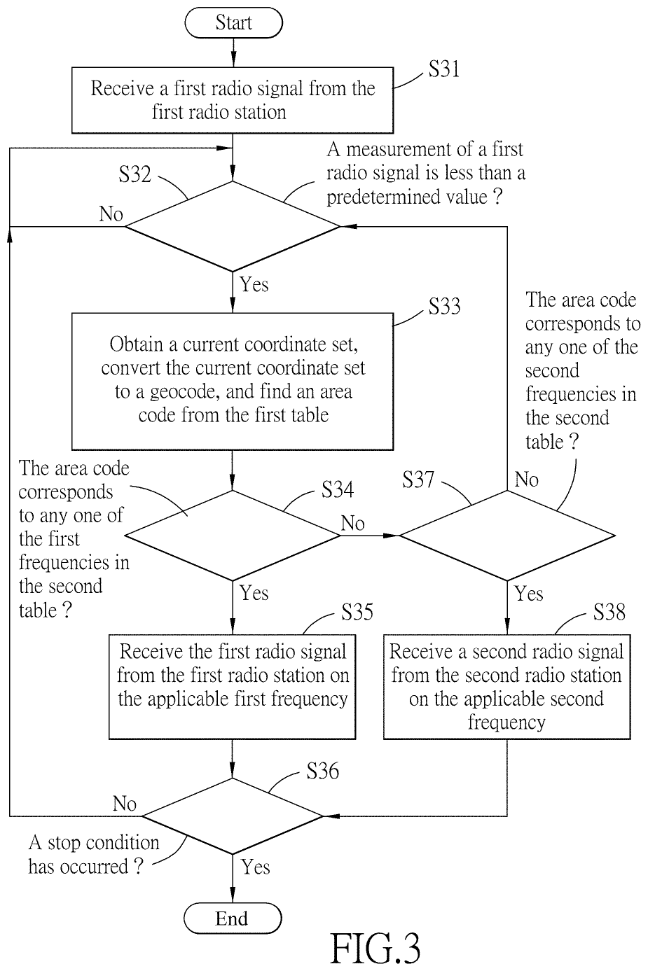

Referring to FIG. 2, for example, when the vehicle 2 departs from Area A and is moving toward a destination (e.g., Area N) through Areas B, C, D, E, etc., a user (e.g., a driver of the vehicle 2) intends to listen to a radio program provided by the first radio station and therefore operates the operation interface 15 to input an operation command indicating a frequency of the first radio station (i.e., the frequency (a)) to the processing unit 14. As shown in FIG. 3, in step S31, in response to receipt of the operation command indicating the frequency (a), the processing unit 14 transmits a tuning signal indicating the frequency (a) to the radio-receiving unit 12. Accordingly, the radio-receiving unit 12 receives a first radio signal from the first radio station on the frequency (a) according to the tuning signal, and outputs the radio program (i.e., the content carried by the first radio signal) through the speaker of the vehicle 2. The processing unit 14 then controls the display module 17 to display information about the frequency (i.e., the frequency (a)), on which the radio signal is currently received for playing the radio program.

Since the vehicle 2 is moving, for example, from Area A to Area B, the closer the vehicle 2 is to Area B, the weaker the signal strength of the first radio signal received from the first radio station on the frequency (a) will be. Therefore, in step S32, the processing unit 14 frequently determines whether a measurement of a first radio signal currently received from the first radio station is less than a predetermined value. The measurement is, for example, received signal strength indicator (RSSI) indicating quality of the first radio signal (i.e., the signal strength). In some embodiments, the processing unit 14 is configured to repeat step S32 at a fixed interval or at a variable interval that may be determined according to speed of traveling of the vehicle 2. When the determination made in step S32 is affirmative, it means that the first radio signal received on the frequency (a) is weak and the user cannot listen to the radio program clearly, and the flow goes to step S33.

In step S33, the processing unit 14 obtains a first current coordinate set of a first current location of the broadcast receiver 1 via the positioning unit 13, converts the first current coordinate set to a first geocode, and finds a first area code that corresponds to the first geocode from among the area codes in the first table. For example, when the vehicle 2 has moved across an area border between Area A and Area B and is now in Area Block 6 of Area B, the first geocode thus obtained will be “bb12” which corresponds to Area Block 6, and accordingly, the processing unit 14 will find “102” which corresponds to Area B as the first area code.

Then, in step S34, the processing unit 14 determines whether the first area code corresponds to any one of the first frequencies in the second table. When it is determined that the first area code corresponds to one of the first frequencies (referred to as “applicable first frequency” hereinafter) in the second table, the flow goes to step S35 to control, by the processing unit 14, the radio-receiving unit 12 to receive the first radio signal from the first radio station on the applicable first frequency. Similarly, the radio-receiving unit 12 outputs the radio program through the speaker of the vehicle 2, and the processing unit 14 controls the display module 17 to display information about the applicable first frequency, on which the radio signal is currently received for playing the radio program.

For example, the first area code “102” found in step S33 corresponds to the frequency (b) in Table 2, and thus the frequency (b) is the applicable first frequency. Then, in step S35, the processing unit 14 transmits a tuning signal indicating the frequency (b) to the radio-receiving unit 12, so that the radio-receiving unit 12 may receive the first radio signal from the first radio station on the frequency (b) according to the tuning signal currently received from the processing unit 14.

Then, in step S36, the processing unit 14 determines whether a stop condition that an engine (not shown) of the vehicle 2 has stopped or that the vehicle 2 has stopped for over a predetermined duration (e.g., 10 minutes or 30 minutes) has occurred. When it is determined that the stop condition has occurred, the method of FIG. 3 is terminated. When the determination made in step S36 is negative, the flow goes back to step S32 to continuously determine whether the measurement of the first radio signal currently received from the first radio station is less than the predetermined value.

By virtue of the method of FIG. 3, when the vehicle 2 moves to Area B, the broadcast receiver 1 can automatically switch to the frequency (b) without user operation. As a result, the user can clearly listen to the radio program broadcasted by the same radio station as the vehicle 2 moves across different areas without manually operating the broadcast receiver 1, which further enhances driving safety.

In should be noted that the processing unit 14 may be configured to obtain geographic coordinate sets via the positioning unit 13 at a sampling frequency that is determined according to the speed of traveling of the vehicle 2 and a size of the area where the vehicle 2 is currently in. The sampling frequency is positively correlated to the speed of traveling of the vehicle 2 and negatively correlated to the size of the area. That is to say, the faster the speed of traveling of the vehicle 2, the greater the sampling frequency, and the smaller the size of the area, the greater the sampling frequency; on the contrary, the slower the speed of traveling of the vehicle 2, the smaller the sampling frequency and the larger the size of the area, the smaller the sampling frequency. By virtue of dynamically determining the sampling frequency, power consumption of the processing unit 14 and the positioning unit 13 can be reduced. For example, the processing unit 14 may determine the size of the area based on a number of the area blocks in the area, and determine the speed of traveling of the vehicle 2 according to a vehicle speed signal provided by a speed sensor. Specifically, the vehicle speed signal is a pulse-width modulation (PWM) signal with a duty cycle related to the speed of traveling of the vehicle 2, and thus the processing unit 14 may calculate the speed of traveling of the vehicle 2 based on the duty cycle of the vehicle speed signal.

In some embodiments, the flow goes to step S37 when it is determined in step S34 that the first area code does not correspond to any one of the first frequencies in the second table. In step S37, the processing unit 14 further determines whether the first area code corresponds to any one of the second frequencies of the second radio station in the second table. When it is determined in step S37 that the first area code corresponds to one of the second frequencies (referred to as “applicable second frequency” hereinafter) in the second table, the flow goes to step S38 to control, by the processing unit 14, the radio-receiving unit 12 to receive a second radio signal from the second radio station on the applicable second frequency. Otherwise, the flow goes back to step S32.

For example, once the vehicle 2 has moved from Area B to Area C (see FIG. 2), the processing unit 14 will find “103” which corresponds to Area C as the first area code in step S33. The first area code “103” does not correspond to any one of the first frequencies in Table 2, which means that the first radio station does not have an applicable frequency corresponding to Area C. Accordingly, the determination made in step S34 will be negative, and the flow goes to step S37 to determine whether the first area code “103” corresponds to any one of the second frequencies of the second radio station in Table 2. The processing unit 14 determines that the first area code “103” corresponds to the frequency (d) (i.e., the applicable second frequency), and then transmits a tuning signal indicating the frequency (d) to the radio-receiving unit 12, so that the radio-receiving unit 12 may receive the second radio signal from the second radio station on the frequency (d) according to the tuning signal currently received from the processing unit 14.

By virtue of implementation of step S37, when the vehicle 2 moves to Area C where the first radio station does not have an applicable frequency to broadcast the first radio signal, the broadcast receiver 1 can automatically switch to the frequency (d) of the second radio station without user operation. As a result, the user can listen to the radio program broadcasted by the desired radio station or a radio program broadcasted by another radio station as the vehicle 2 moves across different areas without manually operating the broadcast receiver 1, which further enhances driving safety.

In a case that the second table includes other frequencies related to radio station(s) other than the first and second radio stations, when it is determined in step S37 that the first area code corresponds to multiple applicable frequencies related respectively to different radio stations in the second table, the processing unit 14 is configured to select one of the applicable frequencies that has the best quality and to transmit the tuning signal indicating the selected one of the applicable frequencies to the radio-receiving unit 12. In some embodiments, for each frequency, the second table may further include information about the signal strength (e.g., RSSI) of the radio signal received on the frequency in the corresponding area (the area that corresponds to the corresponding area code).

In some embodiments, the broadcast receiver 1 further includes a communicating unit 16 electrically connected to the processing unit 14, and the processing unit 14 further includes a networking module 142 (see FIG. 1). The communicating unit 16 may include a mobile communicating module supporting telecommunication using Long-Term Evolution (LTE), the third generation (3G) and/or fourth generation (4G) of wireless mobile telecommunications technology, and/or the like, and is configured to connect to the Internet through a wireless network (e.g., the mobile network, the Internet of Vehicles (IoV), etc.). The networking module 142 is configured to connect to a web resource provided by a radio station over the Internet via the communicating unit 16 to retrieve, from the web resource in real time, program data that has content of an Internet radio program synchronized with a radio program currently being broadcasted by the radio station.

Similar to the geocoding module 141, the networking module 142 may be embodied in: executable software as a set of logic instructions stored in a machine- or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

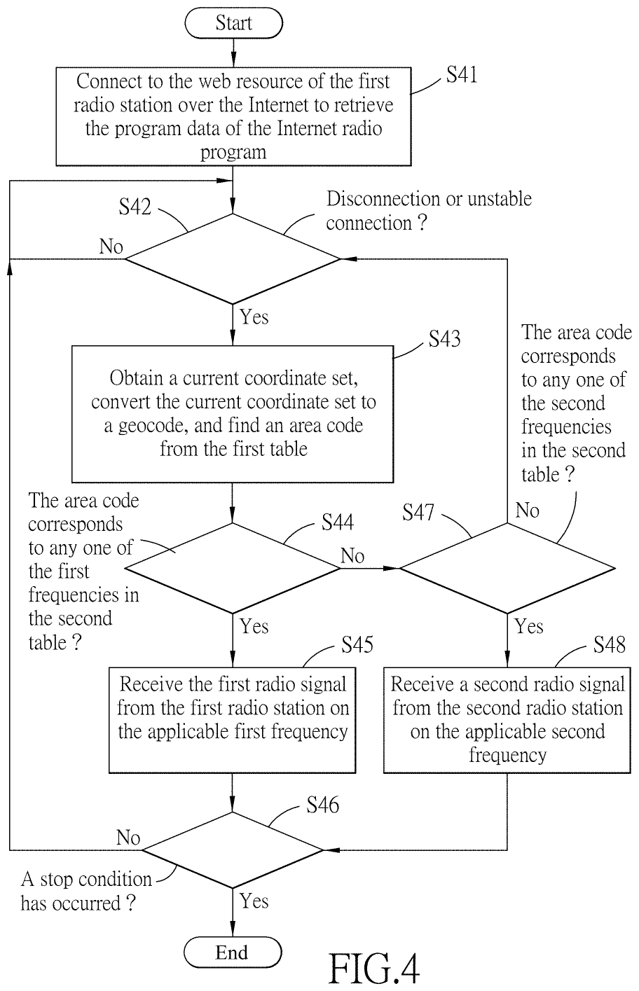

Referring to FIG. 4, when the user of the vehicle 2 intends to listen to an Internet radio program provided by the first radio station and accordingly operates the operation interface 15, the processing unit 14, in response to the user operation, transmits to the networking module 142 a networking signal indicating a web address of the web resource provided by the first radio station in step S41. In response to the networking signal, the networking module 142 connects to the web resource of the first radio station over the Internet via the communicating unit 16 to retrieve therefrom the program data of the Internet radio program, and outputs the Internet radio program through the speaker of the vehicle 2. The processing unit 14 then controls the display module 17 to display information about the first radio station.

In step S42 simultaneous with step S41, the processing unit 14 determines whether one of a first condition that the networking module 142 is disconnected from the web resource of the first radio station and a second condition that connection between the networking module 142 and the web resource of the first radio station is unstable has occurred. For example, the first condition occurs when the vehicle 2 is in an area where there is no wireless network and thus the communication unit 16 cannot access the Internet. The flow goes to step S43 when it is determined that the first condition or the second condition has occurred, and goes back to step S42 when otherwise. Steps S43 to S48 of the method shown in FIG. 4 are similar respectively to steps S33 to S38, and details thereof are omitted herein for the sake of brevity.

By virtue of the method of FIG. 4, the broadcast receiver 1 can automatically switch to an applicable frequency of the first radio station when the networking module 142 cannot connect to the web resource of the first radio station to retrieve the program data of the Internet radio program. Further, if the broadcast receiver 1 cannot receive the first radio signal from the first radio station, the broadcast receiver 1 can automatically switch to an applicable frequency of the second radio station. Accordingly, it can prevent the user from manually operating the broadcast receiver 1 while driving the vehicle 2 when the wireless network is unstable or unavailable, and thus the driving safety may be enhanced.

According to some embodiments, the storage unit 11 further stores a third table including a plurality of available radio stations (i.e., local radio stations) each corresponding to one of the area codes. The following Table 3 is an example of the third table. In this example, Table 3 includes Stations 1-3 corresponding to the area code “101” of Area A, Stations 4 and 5 corresponding to the area code “102” of Area B, and Stations 6-8 corresponding to the area code “103” of Area C. That is to say, the broadcast receiver 1 can receive radio signals from Stations 1-3 in Area A, receive radio signals from Stations 4 and 5 in Area B, and receive radio signals from Stations 6-8 in Area C.

TABLE 3

| Area Code | Local Radio Station |
|---|---|
| 101 | Station 1 |
| (Area A) | Station 2 |
| | Station 3 |
| 102 | Station 4 |
| (Area B) | Station 5 |
| 103 | Station 6 |
| (Area C) | Station 7 |
| | Station 8 |

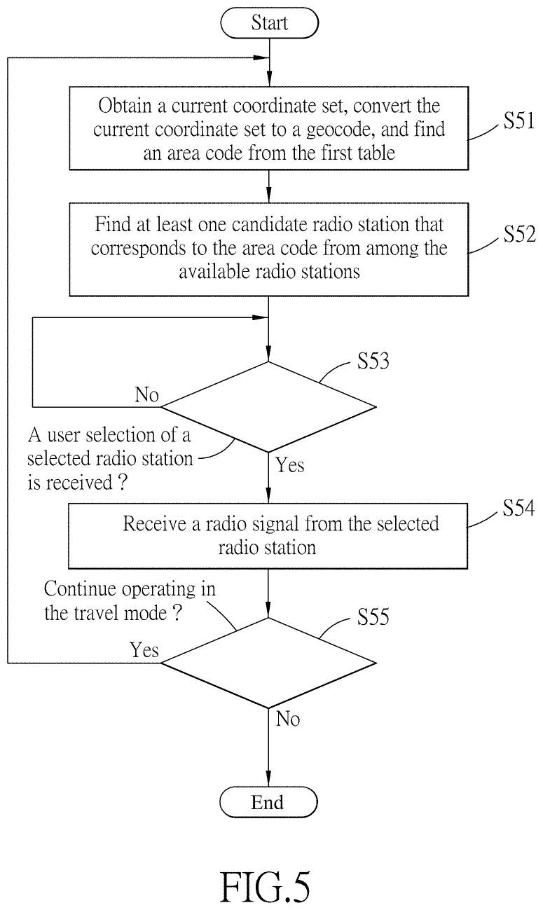

Referring to FIG. 5, when the user drives the vehicle 2 to an area and intends to listen to a radio program broadcasted by a local radio station in this area, the user can operate the operation interface 15 to input a user input instructing the processing unit 14 to operate in a travel mode. In response to the user input received via the operation interface 15, the processing unit 14 operates in the travel mode by implementing the following steps S51 to S55.

In step S51, the processing unit 14 obtains a second current coordinate set of a second current location of the broadcast receiver 1 via the positioning unit 13, converts the second current coordinate set to a second geocode, and then finds a second area code that corresponds to the second geocode from among the area codes in the first table.

Then, in step S52, the processing unit 14 finds, from among the available radio stations in the third table, at least one candidate radio station that corresponds to the second area code, and provides a candidate radio station list including the candidate radio station(s) thus found for the user to select from. For example, the processing unit 14 may control the display module 17 to display the candidate radio station list, or control the speaker of the vehicle 2 to output an audio signal sounding the candidate radio station list. Then, the user can operate the operation interface 15 to select a selected radio station from the candidate radio station list.

For example, when the vehicle 2 is now in Area Block 10 of Area C, the processing unit 14 will obtain the geocode “cc12” as the second geocode and thus find the area code “103” as the second area code from Table 1 (step S51). Then, in step S52, the processing unit 14 finds Stations 6-8 corresponding to the area code “103” as the candidate radio stations from Table 3.

In step S53, the processing unit 14 determines whether a user selection of a selected radio station is received. The flow goes to step S54 when the user selection is received, and goes back to step S53 when otherwise.

In step S54, upon receiving, via the operation interface 15, the user selection of the selected radio station, the processing unit 14 controls the radio-receiving unit 12 to receive a radio signal from the selected radio station, so that the radio-receiving unit 12 outputs the radio program broadcasted by the selected radio station through the speaker of the vehicle 2.

In step S55, the processing unit 14 determines whether to continue operating in the travel mode. For example, the user may operate the operation interface 15 to terminate the travel mode. Upon receiving the user operation to terminate the travel mode, the processing unit 14 stops operating in the travel mode and the procedure of FIG. 5 ends. Otherwise, the flow goes back to step S51.

It should be noted that, before providing the candidate radio station list to the user in step S52, the processing unit 14 may first determine, for each of the candidate radio stations in the candidate radio station list, the signal strength of the radio signal received from the candidate radio station, and arrange the candidate radio stations in a specific order according to signal strength. For example, in the candidate radio station list, Station 7, Station 6 and Station 8 may be arranged in this order, which means that the radio signal received from Station 7 has the greatest signal strength and the radio signal received from Station 8 has the lowest signal strength. In some embodiments, the processing unit 14 may further omit a candidate radio station from the candidate radio station list when the signal strength of the radio signal received therefrom is too weak (e.g., less than a predetermined value) before providing the candidate radio station list to the user. In some embodiments, the processing unit 14 may be further configured to determine a size of the candidate radio station list (i.e., a number of candidate radio stations to be included in the candidate radio station list) to be provided to the user based on the size of the area where the vehicle 2 is currently in and a number of the local (available) radio stations in this area.

According to some embodiments, the storage unit 11 further stores a fourth table including a plurality of available frequencies each corresponding to at least one of the area codes. The following Table 4 is an example of the fourth table. In this example, Table 4 includes Frequencies I to VIII, wherein Frequencies I, II, III and IV correspond to the area code “101” of Area A, Frequencies II, V and VI correspond to the area code “102” of Area B, and Frequencies II, VI, VII and VIII correspond to the area code “103” of Area C. That is to say, a radio receiver (e.g., the broadcast receiver 1) can receive radio signals on Frequencies I, II, III and IV in Area A, receive radio signals on Frequencies II, V and VI in Area B, and receive radio signals on Frequencies II, VI, VII and VIII in Area C. Some of the available frequencies (e.g., Frequencies II and VI) can be used to broadcast radio signals in more than one area.

TABLE 4

| AreaCode | Available Frequency |
|---|---|
| 101 | Frequency I |
| (Area A) | Frequency II |
| | Frequency III |
| | Frequency IV |
| 102 | Frequency II |
| (Area B) | Frequency V |
| | Frequency VI |
| 103 | Frequency II |
| (Area C) | Frequency VI |
| | Frequency VII |
| | Frequency VIII |

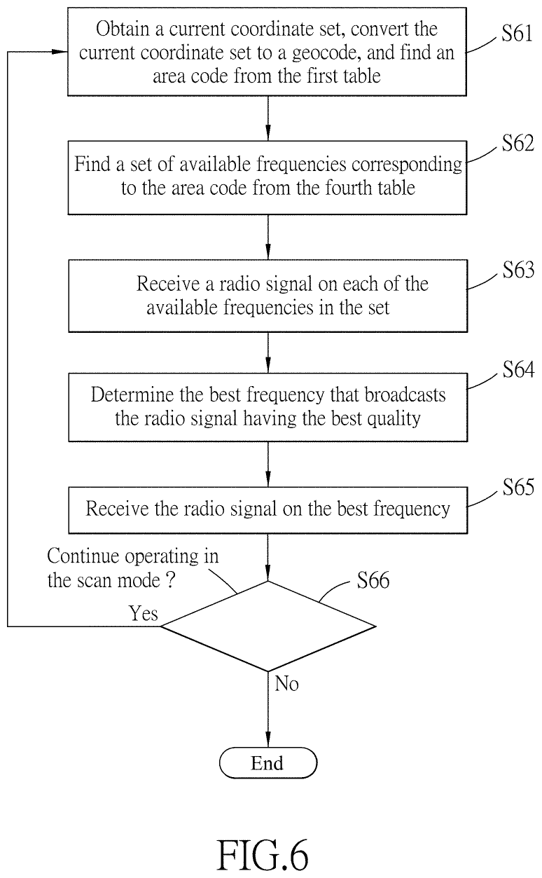

In some embodiments, the processing unit 14 is further configured to operate in a scan mode. When the user operates the operation interface 15 to input a user operation instructing the processing unit 14 to operate in the scan mode, the processing unit 14 operates in the scan mode by implementing the following steps S61 to S66 (see FIG. 6) in response to receipt of the user operation via the operation interface 15.

In step S61, the processing unit 14 obtains a third current coordinate set of a third current location of the broadcast receiver 1 via the positioning unit 13, converts the third current coordinate set to a third geocode, and finds a third area code that corresponds to the third geocode from among the area codes in the first table. Subsequently, in step S62, the processing unit 14 finds, from the available frequencies in the fourth table, a set of available frequencies including those of the available frequencies that correspond to the third area code.

For example, when the vehicle 2 is now in Area Block 7 of Area B, the processing unit 14 will obtain the geocode “bb13” as the third geocode and thus find the area code “102” as the third area code from Table 1 (step S61). Then, in step S62, the processing unit 14 finds Frequencies II, V and VI corresponding to the area code “102” from Table 4.

Then, the processing unit 14 controls the radio-receiving unit 12 to receive a radio signal on each of the available frequencies in the set (i.e., Frequencies II, V and VI) (step S63), and determines which one of the available frequencies in the set broadcasts the radio signal having the best quality (referred to as “best frequency” hereinafter) (step S64) In step S65, the processing unit 14 controls the radio-receiving unit 12 to receive the radio signal on the best frequency thus determined. Specifically, the processing unit 14 transmits a tuning signal indicating the best frequency to the radio-receiving unit 12, so that the radio-receiving unit 12 receives the radio signal on the best frequency according to the tuning signal.

In step S66, the processing unit 14 determines whether to continue operating in the scan mode. For example, the user may operate the operation interface 15 to terminate the scan mode. Upon receiving the user operation to terminate the scan mode, the processing unit 14 stops operating in the scan mode and the procedure of FIG. 6 ends. Otherwise, the flow goes back to step S61.

In some embodiments, the broadcast receiver 1 may be configured to provide location-based information by geofencing technique without requiring connection to the Internet and an electronic map, and the storage unit 11 further stores a fifth table including a plurality of representative coordinate sets that correspond respectively to a plurality of administrative divisions of the region. In the case that the region is the main island of Taiwan, there are nineteen administrative divisions including six special municipalities (i.e., Taipei City, New Taipei City, Taoyuan City, etc.), three (provincial) cities (i.e., Hsinchu City, Chiayi City and Keelung City) and ten counties (i.e., Hsinchu County, Pingtung County, etc.). For each of the administrative divisions, the representative coordinate set is, but not limited to, a coordinate set of a geometric center point of the administrative division. The following Table 5 is an example of the fifth table. Table 5 includes five administrative divisions (i.e., Divisions 1 to 5) and five representative coordinate sets (i.e., Coordinate Sets A to E).

TABLE 5

| Administrative Division | Representative Coordinate Set |
|---|---|
| Division 1 | Coordinate Set A |
| Division 2 | Coordinate Set B |
| Division 3 | Coordinate Set C |
| Division 4 | Coordinate Set D |
| Division 5 | Coordinate Set E |

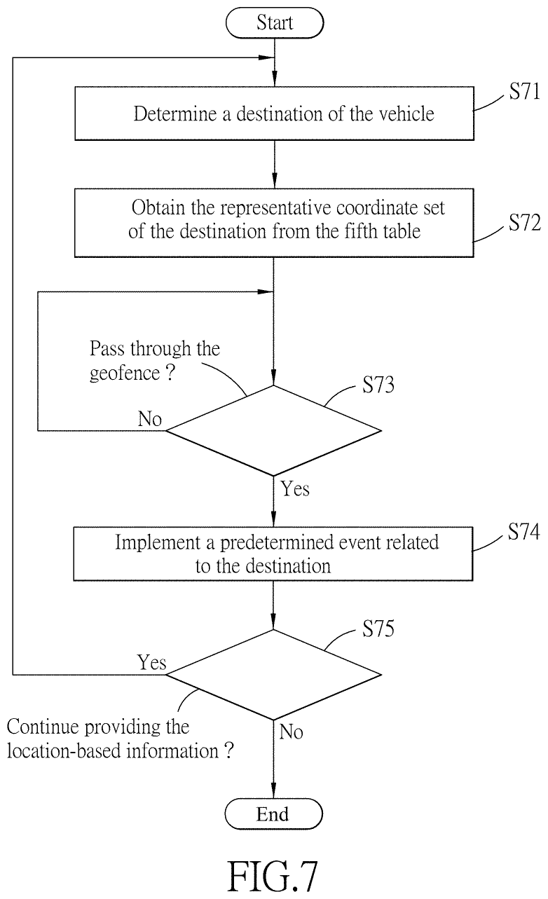

Referring to FIG. 7, the processing unit 14 is configured to provide the location-based information by implementing steps S71 to S75.

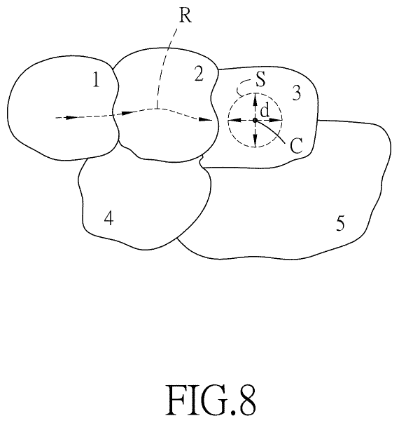

In step S71, the processing unit 14 continuously obtains geographic coordinate sets via the positioning unit 13, determines a destination one of the administrative divisions the vehicle is moving toward (hereinafter referred to as “destination”) based on the representative coordinate sets and the geographic coordinate set. Specifically, in step S71, the processing unit 14 calculates a route that the vehicle 2 is traveling based on the geographic coordinate sets so as to know which one(s) of the administrative divisions the vehicle 2 has passed through, determines a travel direction that the vehicle 2 is moving in according to the route, and then determines the destination according to the travel direction. Referring to FIG. 8 as an example, the processing unit 14 calculates a route (R) of the vehicle 2 that has passed through Division 1 and is currently in Division 2, and then determines that the destination is Division 3.

In step S72, the processing unit 14 obtains the representative coordinate set of the destination from the fifth table, and defines a geofence (i.e., a virtual perimeter) based on the representative coordinate set of the destination. For example, the geofence is an imaginary circle having a predetermined radius and centered at the representative coordinate set of the destination. As shown in FIG. 8, the geofence is the imaginary circle (S) having a center at Coordinate Set C of Division 3 and a radius of a predetermined distance (d) from the center.

In step S73, the processing unit 14 determines whether a distance between the geographic coordinate set currently obtained and the representative coordinate set corresponding to the destination is less than a predetermined distance (i.e., the predetermined distance (d) in FIG. 8). When it is determined that the distance between the geographic coordinate set currently obtained and the representative coordinate set corresponding to the destination is less than the predetermined distance (i.e., the vehicle 2 has entered the geofence), the flow goes to step S74 to implement, by the processing unit 14, a predetermined event related to the destination. The flow goes back to step S73 when otherwise.

For example, the predetermined event may include, but is not limited to, outputting information about the destination via the display module 17 and/or the speaker of the vehicle 2. Such information is pre-stored in the storage unit 11, and includes, for example, scenic sites within the destination, campaigns and activities held in the destination, general climate of the destination, etc. In some embodiments, when the determination made in step S73 is affirmative (i.e., the vehicle 2 has passed through the geofence to enter an area surrounded by the geofence), the processing unit 14 implements the predetermined event by operating in the travel mode (see FIG. 5).

Then, in step S75, the processing unit 14 determines whether to continue providing the location-based information. For example, the user may operate the operation interface 15 to make the broadcast receiver 1 stop providing the location-based information. Upon receiving the user operation to stop providing the location-based information, the processing unit 14 stops providing the location-based information and the method of FIG. 7 ends. Otherwise, the flow goes back to step S71.

In some embodiments, the broadcast receiver 1 may be further configured to provide a first quick-switching function allowing the user to quickly switch between two pre-stored frequencies, a second quick-switching function allowing the user to quickly switch among a plurality of preference frequencies, and a third quick-switching function allowing the user to quickly switch among a plurality of frequencies belonging to a broadcast network.

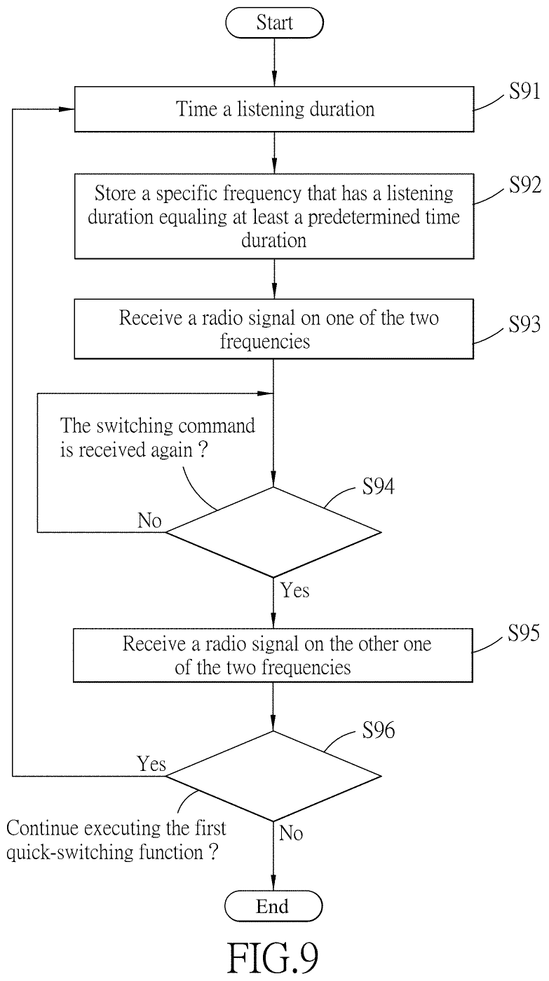

Referring to FIG. 9, when the user intends to use the first quick-switching function, the user can operate the operation interface 15 to start the first quick-switching function. Upon receiving the user operation to start the first quick-switching function via the operation interface 15, for each frequency, the processing unit 14 times a listening duration, in which the radio-receiving unit 12 receives a radio signal from the frequency (step S91).

In step S92, when a listening duration of a specific frequency reaches a predetermined time duration, the processing unit 14 stores the specific frequency therein. Specifically, the processing unit 14 includes a processor register 140 having two storage areas (see FIG. 1), and is configured to store the specific frequency in a first-in-first-out manner such that when the storage areas respectively store two pre-stored frequencies therein, one of the pre-stored frequencies that was stored earlier than the other one of the pre-stored frequencies is deleted from the corresponding one of the storage areas and a to-be-stored frequency to be stored currently is then stored in the corresponding one of the storage areas. By the first-in-first-out manner, the storage areas of the processor register 140 always store two frequencies that are stored in the storage areas the latest.

In step S93, upon receiving a switching command via the operation interface 15, the processing unit 14 controls the radio-receiving unit 12 to receive a radio signal on one of the two frequencies that are currently stored respectively in the storage areas.

In step S94, the processing unit 14 determines whether the switching command is received again while the radio-receiving unit 12 is being controlled to receive the radio signal on said one of the two frequencies. When it is determined that the switching command is received again, the processing unit 14 controls the radio-receiving unit 12 to receive a radio signal on the other one of the two frequencies (step S95). Otherwise, the flow goes back to step S94.

In step S96, the processing unit 14 determines whether to continue executing the first quick-switching function. For example, the user may operate the operation interface 15 to terminate the first quick-switching function. Upon receiving the user operation to terminate the first quick-switching function, the processing unit 14 stops executing the first quick-switching function and the procedure of FIG. 9 ends. Otherwise, the flow goes back to step S91.

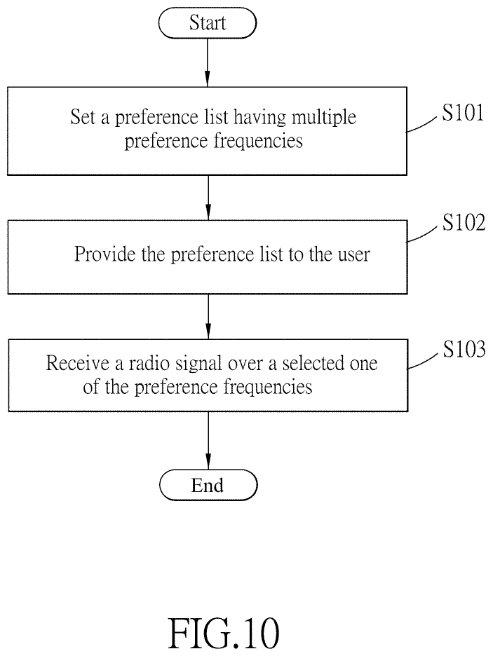

Referring to FIG. 10, when the user intends to use the second quick-switching function, the user can operate the operation interface 15 to start the second quick-switching function. Upon receiving the user operation to start the second quick-switching function via the operation interface 15, the processing unit 14 sets a preference list including, for example, three preference frequencies (step S101). Specifically, for each frequency, the processing unit 14 records a number of listening times that the radio-receiving unit 12 receives a radio signal on the frequency within a predetermined duration (e.g., one day or one week), and sets the frequency as a preference frequency when the number of listening times reaches a predetermined value (e.g., ten). In this embodiment, the processing unit 14 is configured to continuously update the preference list. That is to say, when the number of listening times of another frequency exceeds that of one of the three preference frequencies in the preference list, the processing unit 14 omits said one of the three preference frequencies from the preference list and adds said another frequency as a preference frequency in the preference list.

In step S102, in response to a user operation received via the operation interface 15, the processing unit 14 provides the preference list for the user to select from. For example, the processing unit 14 may control the display module 17 to display the preference frequencies, or control the speaker of the vehicle 2 to output an audio signal sounding the preference frequencies. In some embodiments, before providing the preference list to the user, the processing unit 14 may first determine the signal strength of the radio signal received on each of the preference frequencies and arrange the preference frequencies in a specific order according to signal strength. In some embodiments, the processing unit 14 may further omit a preference frequency from the preference list when the signal strength of the radio signal received on this preference frequency is too weak (e.g., less than a predetermined value) before providing the preference list to the user.

Upon receiving, via the operation interface 15, a user selection of one of the preference frequencies, the processing unit 14 controls the radio-receiving unit 12 to receive a radio signal on said one of the preference frequencies (step S103).

In some embodiments, the storage unit 11 further stores a plurality of broadcast networks each having a plurality of frequencies. For example, the storage unit 11 stores Frequencies A1, A2 and A3 belonging to a first broadcast network, and Frequencies B1, B2, B3 and B4 belonging to a second broadcast network.

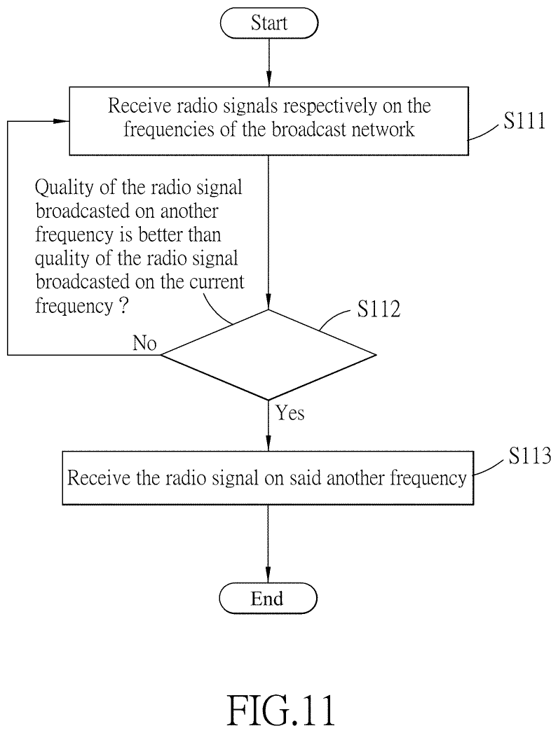

Referring to FIG. 11, when the user intends to use the third quick-switching function, the user can operate the operation interface 15 to start the third quick-switching function. Upon receiving the user operation to start the third quick-switching function via the operation interface 15, the processing unit 14 executes the third quick-switching function, and when the radio-receiving unit 12 is receiving a radio on a current one of the frequencies that belongs to one of the broadcast networks (e.g., Frequency A1 of the first broadcast network), controls the radio-receiving unit 12 to receive radio signals respectively on the frequencies belonging to said one of the broadcast networks (e.g., on Frequencies A1, A2 and A3) (step S111).

In step S112, the processing unit 14 determines whether quality of the radio signal broadcasted on another one of the frequencies belonging to said one of the broadcast networks is better than quality of the radio signal broadcasted on the current one of the frequencies (Frequency A1). When it is determined that the quality of the radio signal broadcasted on another one of the frequencies belonging to said one of the broadcast networks (e.g., Frequency A2) is better than the quality of the radio signal broadcasted on the current one of the frequencies (Frequency A1), the flow goes to step S113 to control, by the processing unit 14, the radio-receiving unit 12 to receive the radio signal on said another one of the frequencies (Frequency A2). Otherwise, the flow goes back to step S111. In this way, the broadcast receiver 1 always receives the radio signal having the best quality from the desired broadcast network.

In some embodiments, the storage unit 11 further stores a program guide including a plurality of radio programs each corresponding to an airtime, at which the radio program is broadcasted, and a frequency, on which the radio program is broadcasted. The following Table 6 is an example of the program guide.

TABLE 6

| | Weekday | | Saturday | | Sunday | |
|---|---|---|---|---|---|---|
| | Program | Airtime | Program | Airtime | Program | Airtime |
| Frequency A | AA-1 | 00:00-01:00 | CC-1 | 00:00-01:00 | EE-1 | 00:00-01:00 |
| (FM) | AA-2 | 01:00-02:00 | CC-2 | 01:00-02:00 | EE-2 | 01:00-02:00 |
| | . | . | . | . | . | . |
| | . | . | . | . | . | . |
| | . | . | . | . | . | . |
| | AA-N | 23:00-24:00 | | | | |
| Frequency B | BB-1 | 00:00-01:00 | DD-1 | 00:00-01:00 | FF-1 | 00:00-01:00 |
| (AM) | BB-2 | 01:00-02:00 | DD-2 | 01:00-02:00 | FF-2 | 01:00-02:00 |
| | . | . | . | . | . | . |
| | . | . | . | . | . | . |
| | . | . | . | . | . | . |
| | BB-M | 23:00-24:00 | | | | |

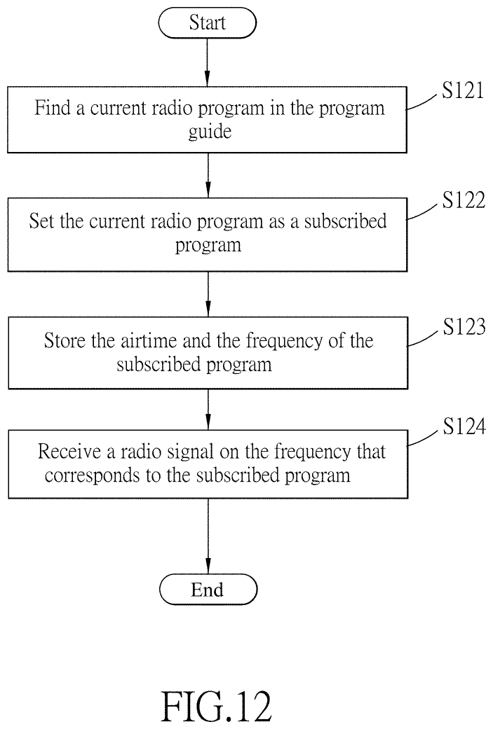

Referring to FIG. 12, the broadcast receiver 1 is further configured to automatically play a subscribed radio program according to an embodiment of this disclosure.

In step S121, when the radio-receiving unit 12 is receiving a radio signal on a current frequency, in response to a subscribing command received via the operation interface 15, the processing unit 14 finds a current one of the radio programs in the program guide based on the current frequency and the time when the radio-receiving unit 12 is receiving the radio signal on the current frequency. For example, when the radio-receiving unit 12 receives a radio signal on Frequency A on Wednesday at 01:10, the processing unit 14 will find Program AA-2 from the program guide.

Subsequently, in step S122, the processing unit 14 sets the current one of the radio programs (e.g., Program AA-2) as a subscribed program. In step S123, the processing unit 14 retrieves the airtime (e.g., 01:00-02:00) and the frequency (e.g., Frequency A) that correspond to the subscribed program from the program guide, and stores the airtime and the frequency retrieved from the program guide. For example, the processing unit 14 is configured to store the airtime and the frequency thus retrieved in the processor register 140.

After step S123, when a current time point is within the airtime that corresponds to the subscribed program, the processing unit 14 controls, in step S124, the radio-receiving unit 12 to receive a radio signal on the frequency that corresponds to the subscribed program. For example, when the broadcast receiver 1 is activated on a weekday at 01:00 (i.e., corresponding to the air time of the subscribed program, Program AA-2), the processing unit 14 will control the radio-receiving unit 12 to receive the radio signal on Frequency A and to play the subscribed program (Program AA-2) through the speaker of the vehicle 2. Since each radio station may adjust a program guide thereof, for example, every month, the processing unit 14 is configured to download the latest program guide from each radio station through the communicating unit 16 and store the latest program guide in the storage unit 11 periodically.

To sum up, by virtue of the data included in the first and second tables, the broadcast receiver 1 can automatically switch to an applicable frequency of a radio station in the region according to embodiments of this disclosure. As a result, the user can clearly listen to the radio program broadcasted by the same radio station when the vehicle 2 moves across different areas without manually operating the broadcast receiver 1, which further enhances driving safety.

According to one embodiment, there is provided a non-transitory computer-readable storage medium storing instructions that, when executed by a processor of an electronic device communicating with a plurality of vehicles, cause the processor to perform steps of the method/procedure of one or more of FIGS. 3-7 and FIGS. 9-12.

According to one embodiment, there is provided an application-specific integrated circuit (ASIC) that includes circuit blocks which, when integrated with an electronic device communicating with a plurality of vehicles, cause the electronic device to perform steps of the method/procedure of one or more of FIGS. 3-7 and FIGS. 9-12.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A broadcast receiver configured to automatically switch to an applicable frequency of a radio station in a region, the region having a plurality of areas each of which is divided into a plurality of area blocks, said broadcast receiver comprising:
a storage unit storing
a first table including a plurality of area codes associated respectively with the areas, and a plurality of geocodes each of which is related to all geographic coordinate sets covered by a respective one of the area blocks and each of which corresponds to one of the area codes that is associated with the area having the respective one of the area blocks, and
a second table including at least one first frequency related to a first radio station, each of the at least one first frequency corresponding to one of the area codes;
a radio-receiving unit configured to receive a radio signal;
a positioning unit configured to obtain a geographic coordinate set of a location where said broadcast receiver is located; and
a processing unit electrically connected to said storage unit, said radio-receiving unit and said positioning unit, and configured to
determine whether a measurement of a first radio signal currently received from the first radio station is less than a predetermined value, the measurement indicating quality of the first radio signal, and
when it is determined that the measurement of the first radio signal is less than the predetermined value, obtain a first current coordinate set of a first current location of said broadcast receiver via said positioning unit, convert the first current coordinate set to a first geocode, find a first area code that corresponds to the first geocode from among the area codes in the first table, determine whether the first area code corresponds to any one of the at least one first frequency in the second table, and when it is determined that the first area code corresponds to one of the at least one first frequency in the second table, control said radio-receiving unit to receive the first radio signal from the first radio station on said one of the at least one first frequency.

2. The broadcast receiver of claim 1, wherein the second table further includes at least one second frequency related to a second radio station, each of the at least one second frequency of the second radio station corresponding to one of the area codes,
wherein said processing unit is further configured to, when it is determined that the first area code does not correspond to any one of the at least one first frequency in the second table,
determine whether the first area code corresponds to any one of the at least one second frequency of the second radio station in the second table, and
when it is determined that the first area code corresponds to one of the at least one second frequency of the second radio station in the second table, control said radio-receiving unit to receive a second radio signal from the second radio station over said one of the at least one second frequency.

3. The broadcast receiver of claim 2, further comprising:
a communicating unit electrically connected to said processing unit and configured to connect to the Internet,
wherein said processing unit includes a networking module configured to connect to a web resource provided by the first radio station over the Internet via said communicating unit to retrieve, from the web resource in real time, program data that has content of an Internet radio program synchronized with a radio program currently broadcasted by the first radio station through the first radio signal, and said processing unit is further configured to
determine whether one of a first condition that said networking module is disconnected from the web resource of the first radio station and a second condition that connection between said networking module and the web resource of the first radio station is unstable has occurred,
when it is determined that one of the first condition and the second condition has occurred, obtain a second current coordinate set of a second current location of said broadcast receiver via said positioning unit,
convert the second current coordinate set to a second geocode,
find a second area code that corresponds to the second geocode from among the area codes in the first table,
determine whether the second area code corresponds to any one of the at least one first frequency in the second table,
when it is determined that the second area code corresponds to one of the at least one first frequency in the second table, control said radio-receiving unit to receive the first radio signal from the first radio station on said one of the at least one first frequency that corresponds to the second area code,
when it is determined that the second area code does not correspond to any one of the at least one first frequency in the second table, determine whether the second area code corresponds to any one of the at least one second frequency of the second radio station in the second table, and
when it is determined that the second area code corresponds to one of the at least one second frequency of the second radio station in the second table, control said radio-receiving unit to receive the second radio signal from the second radio station on said one of the at least one second frequency that corresponds to the second area code.

4. The broadcast receiver of claim 1, wherein said storage unit further stores a third table including a plurality of available radio stations each of which corresponds to one of the area codes,
wherein said broadcast receiver further comprises an operation interface electrically connected to said processing unit, and said processing unit is further configured, in response to a user input received via said operation interface, to operate in a travel mode to
obtain a second current coordinate set of a second current location of said broadcast receiver via said positioning unit,
convert the second current coordinate set to a second geocode,
find a second area code that corresponds to the second geocode from among the area codes in the first table,
find, from among the available radio stations in the third table, at least one candidate radio station that corresponds to the second area code from the third table,
provide the at least one candidate radio station that corresponds to the second area code for a user to select from, and
upon receiving, via said operation interface, a user selection of one of the at least one candidate radio station that corresponds to the second area code, control said radio-receiving unit to receive a radio signal from said one of the at least one candidate radio station.

5. The broadcast receiver of claim 1, wherein said storage unit further stores a third table including a plurality of available frequencies each of which corresponds to at least one of the area codes,
wherein said broadcast receiver further comprises an operation interface electrically connected to said processing unit, and said processing unit is further configured, in response to a user operation received via said operation interface, to operate in a scan mode to
obtain a second current coordinate set of a second current location of said broadcast receiver via said positioning unit,
convert the second current coordinate set to a second geocode,
find a second area code that corresponds to the second geocode from among the area codes in the first table,
find, from the available frequencies in the third table, a set of available frequencies including those of the available frequencies that correspond to the second area code,
control said radio-receiving unit to receive a radio signal over each of the set of the available frequencies,
determine which one of the available frequencies in the set broadcasts the radio signal having the best quality, and
control said radio-receiving unit to receive the radio signal having the best quality on said one of the available frequencies in the set.

6. The broadcast receiver of claim 1, wherein said storage unit further stores a third table including a plurality of representative coordinate sets that correspond respectively to a plurality of administrative divisions of the region,
wherein said broadcast receiver is installed on a vehicle, and said processing unit is further configured to
continuously obtain a plurality of geographic coordinate sets via said positioning unit,
determine a destination one of the administrative divisions the vehicle is moving toward based on the representative coordinate sets and the geographic coordinate sets,
determine whether a distance between the geographic coordinate set currently obtained and the representative coordinate set that corresponds to the destination one of the administrative divisions is less than a predetermined distance, and
when it is determined that the distance between the geographic coordinate set currently obtained and the representative coordinate set that corresponds to the destination one of the administrative divisions is less than the predetermined distance, implement a predetermined event related to the destination one of the administrative divisions.

7. The broadcast receiver of claim 6, further comprising a display module electrically connected to said processing unit,
wherein the predetermined event implemented by said processing unit includes outputting information about the destination one of the administrative divisions via said display module.

8. The broadcast receiver of claim 6, wherein said storage unit further stores a fourth table including a plurality of available radio stations, each of the area codes corresponding to at least one of the available radio stations,
wherein said broadcast receiver further comprises an operation interface electrically connected to said processing unit, and the predetermined event implemented by said processing unit includes operating in a travel mode to
obtain a second current coordinate set of a second current location of said broadcast receiver via said positioning unit,
convert the second current coordinate set to a second geocode,
find a second area code that corresponds to the second geocode from among the area codes in the first table,
find, from among the available radio stations in the third table, at least one of candidate radio station that corresponds to the second area code from the third table,
provide the at least one of candidate radio station that corresponds to the second area code for a user to select from, and
upon receiving, via said operation interface, a user selection of one of the at least one candidate radio station that corresponds to the second area code, control said radio-receiving unit to receive a radio signal from said one of the at least one candidate radio station.

9. The broadcast receiver of claim 1, further comprising an operation interface electrically connected to said processing unit,
wherein said processing unit includes a processor register having two storage areas, and is further configured to
for each frequency, time a listening duration, in which said radio-receiving unit receives a radio signal from the frequency,
when the listening duration reaches a predetermined time duration, store the frequency in one of the storage areas in a first-in-first-out manner such that when the storage areas respectively store two pre-stored frequencies, one of the pre-stored frequencies that was stored earlier than the other one of the pre-stored frequencies is deleted from the corresponding one of the storage areas and a to-be-stored frequency to be stored currently is then stored in the corresponding one of the storage areas,
upon receiving a switching command via said operation interface, control said radio-receiving unit to receive a radio signal on one of two frequencies that are currently stored respectively in the storage areas,
determine whether the switching command is received again while said radio-receiving unit is being controlled to receive the radio signal on said one of the two frequencies, and
when it is determined that the switching command is received again, control said radio-receiving unit to receive a radio signal on the other one of the two frequencies.

10. The broadcast receiver of claim 1, further comprising an operation interface electrically connected to said processing unit,
wherein said processing unit is further configured to
set a plurality of preference frequencies by
for each frequency, recording a number of listening times that said radio-receiving unit receives a radio signal on the frequency within a predetermined duration, and
when the number of listening times reaches a predetermined value, setting the frequency as a preference frequency,
in response to a user operation received via said operation interface, provide the preference frequencies for a user to select from, and
upon receiving, via said operation interface, a user selection of one of the preference frequencies, control said radio-receiving unit to receive a radio signal on said one of the preference frequencies.

11. The broadcast receiver of claim 1, further comprising an operation interface electrically connected to said processing unit,
wherein said storage unit further stores a plurality of frequencies belonging to a broadcast network, and said processing unit is further configured to
when said radio-receiving unit is receiving a radio signal on a current one of the frequencies of the broadcast network, control said radio-receiving unit to receive radio signals respectively on the frequencies that belong to the broadcast network in response to a user operation via said operation interface, and
when it is determined that quality of the radio signal broadcasted on another one of the frequencies belonging to the broadcast network is better than quality of the radio signal broadcasted on the current one of the frequencies belonging to the broadcast network, control said radio-receiving unit to receive the radio signal on said another one of the frequencies belonging to the broadcast network.

12. The broadcast receiver of claim 1, further comprising an operation interface electrically connected to said processing unit,
wherein said storage unit further stores a program guide including a plurality of radio programs each corresponding to an airtime, at which the radio program is broadcasted, and a frequency, on which the radio program is broadcasted, and said processing unit is further configured to
when said radio-receiving unit is receiving a radio signal on a current frequency, in response to a subscribing command received via said operation interface, find a current one of the radio programs in the program guide based on the current frequency and a time when said radio-receiving unit is receiving the radio signal on the current frequency,
set the current one of the radio programs as a subscribed program,
retrieve the airtime and the frequency corresponding to the subscribed program from the program guide, and store the airtime and the frequency retrieved from the program guide, and
after storing the airtime and the frequency that correspond to the subscribed program, when a current time point is within the airtime that corresponds to the subscribed program, control said radio-receiving unit to receive a radio signal on the frequency that corresponds to the subscribed program.
